(19) United States
(12) Patent Application Publication
(10) Pub. No.: US 2025/0045659 A1
(43) Pub. Date: Feb. 6, 2025

(54) INFORMATION PROCESSING DEVICE AND INFORMATION PROCESSING METHOD

(71) Applicant: TELEXISTENCE INC., Tokyo (JP)

(72) Inventors: Jin TOMIOKA, Tokyo (JP); Genki SANO, Tokyo (JP); Tomoyuki KOBAYASHI, Tokyo (JP); Takumi TACHIBANA, Tokyo (JP)

(73) Assignee: TELEXISTENCE INC., Tokyo (JP)

(21) Appl. No.: 18/716,208

(22) PCT Filed: Dec. 19, 2022
(86) PCT No.: PCT/JP2022/046594

§ 371 Date: Jun. 4, 2024

(30) Foreign Application Priority Data
Dec. 20, 2021 (JP) 2021-206466

(51) Int. Cl. G06Q 10/0631; G06Q 40/12

(52) U.S. Cl. CPC G06Q 10/06312; G06Q 40/125

(57) ABSTRACT

A work management apparatus according to an embodiment of the present disclosure includes a control unit. The control unit is configured to perform: obtaining information indicating stay time of a worker who performs work in a workplace including a plurality of areas, in each of the plurality of areas; calculating work actual condition data indicating work time of the work performed in each of the plurality of areas; identifying a substitutable task which is substituted or assisted by introduction of a predetermined device, among a plurality of tasks of the work performed in the workplace; and outputting change information corresponding to a change in the task performed by the worker by introduction of the device, based on relationship between the work time of each of the plurality of tasks indicated by the work actual condition data and the substitutable task.

### TECHNICAL FIELD

The present disclosure relates an information processing apparatus and an information processing method for processing information regarding work performed by a worker in a workplace.

### BACKGROUND

JP2015-141563A discloses a system which detects work performed by a worker based on video taken inside a store, and compares the detection result with a work schedule to display the status of the performed work on a terminal.

### SUMMARY

In the system described in JP2015-141563A, while the user can understand the status of the performed work based on the work schedule, the user needs to think about how to improve the efficiency of the work. However, there was a problem that it is not easy for the user to improve the efficiency of work based only on the status of the performed work.

The present disclosure has been made taking the above point into account, and an object of the present invention is to improve the efficiency of work performed by a user in a workplace.

According to one aspect of the present disclosure, an information processing apparatus is provided. The information processing apparatus includes a control unit, and the control unit is configured to perform: obtaining information indicating stay time of a worker who performs work in a workplace including a plurality of areas, in each of the plurality of areas; calculating work actual condition data indicating work time of the work performed in each of the plurality of areas; identifying a substitutable task which is substituted or assisted by introduction of a predetermined device, among a plurality of tasks of the work performed in the workplace; and outputting change information corresponding to a change in the task performed by the worker by introduction of the device, based on relationship between the work time of each of the plurality of tasks indicated by the work actual condition data and the substitutable task.

The present disclosure offers an advantage in that it becomes easier to improve the efficiency of work performed by a user.

### BRIEF DESCRIPTION OF THE DRAWINGS

FIG. 1 is a schematic view showing a work management system according to an embodiment;

FIG. 2 is a block diagram showing the work management system according to the embodiment;

FIG. 3 is a schematic diagram illustrating a method of obtaining stay information by an acquisition unit;

FIG. 4 is a schematic view showing exemplary work status data calculated by the calculation unit;

FIG. 5 is a schematic view illustrating a method of identifying a substitutable task by an identification unit;

FIG. 6 is a schematic view illustrating a method of identifying a settlement task which can be reduced by the identification unit;

FIG. 7 is a schematic view illustrating a method of identifying a changeable task by the identification unit;

FIG. 8 is a schematic view showing exemplary work actual condition data in a case where the efficiency of a task identified by the identification unit is improved;

FIG. 9 is a schematic view showing an information terminal displaying exemplary change information;

FIG. 10 is a schematic diagram showing a table indicating data in a case where the efficiency of a task identified by the identification unit is improved; and

FIG. 11 is a flow chart showing an information processing method performed by a work management apparatus according to the embodiment.

### DETAILED DESCRIPTION

### [Overview of Work Management System S]

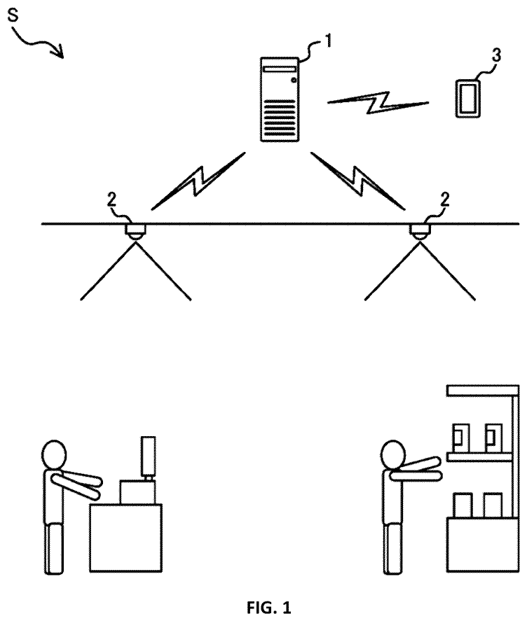

FIG. 1 is a schematic view showing a work management system according to the present embodiment. The work management system S incudes a work management apparatus 1, image capture devices 2, and an information terminal 3. A plurality of image capture devices 2 and a plurality of information terminals 3 may be provided. The work management system S may include other devices such as servers and terminals.

The work management apparatus 1 (information processing apparatus) is a computer for managing information about work performed in a predetermined workplace. The workplace is, for example, a store for selling products, a warehouse for storing and delivering products, and so on. The work is performed by a worker in the workplace. The work may be performed by a robot or other devices instead of the worker. The work management apparatus 1 is connected to the image capture devices 2 and the information terminal 3 by wired or wireless communication.

The image capture device 2 is a device which captures an image of the workplace to generate a capture image. For example, the image capture device 2 is a digital camera. The capture image is information used to identify stay time of a worker in each of a plurality of areas included in the workplace. One or more image capture devices 2 are provided in the workplace to enable images of the plurality of areas to be captured.

The information terminal 3 is a computer used by a user. For example, the information terminal 3 is a smartphone, a tablet terminal, or a personal computer. For example, a user is a manager who manages the work performed in the workplace. The information terminal 3 has a display unit such as a liquid crystal display capable of displaying information received from the work management apparatus 1.

Overview of processes performed by the work management system S in the present embodiment will be described below. The work management apparatus 1 obtains information indicating the stay time of a worker in each of a plurality of areas included in the workplace. For example, the work management apparatus 1 identifies the stay time of the worker in each of the plurality of areas based on the capture image captured by the image capture device 2, and obtains the identified result as information indicating the stay time.

The work management apparatus 1 calculates work actual condition data indicating the work time of the work performed in each of the plurality of areas based on the stay time of the worker. The work management apparatus 1 identifies a task which can be made more efficient, among a plurality of tasks of the work performed in the workplace, based on the work actual condition data.

For example, the work management apparatus 1 identifies a substitutable task which is substituted or assisted by introduction of a predetermined device, among a plurality of tasks of the work performed in the workplace. Examples of the introduced device include a robot which performs a predetermined task, an unmanned settlement device, an automated ordering system, etc.

Further, the work management apparatus 1 identifies a settlement task which can be reduced, for example, based on the duration of the settlement task and the number of customers in the workplace. Further, for example, the work management apparatus 1 identifies, among a plurality of tasks to be performed in the workplace, a changeable task which can change the time frame in which it is performed to another time frame, and identifies the other time frame in which the changeable task is performed.

The work management apparatus 1 generates change information corresponding to changes in the task performed by worker in the case where the efficiency of the identified task is improved, based on the work actual condition data. The change information includes information corresponding to at least one of reducing the work time of the substitutable task by introduction of a predetermined device, reducing the work time of the settlement task based on the number of customers, and changing the substitutable task to another time frame.

As described above, the work management system S calculates work actual condition data indicating the work time of the task performed in each of the plurality of areas based on the stay time of the worker in each of the plurality of areas in the workplace, and identifies the task which can be made more efficient based on the work actual condition data. Then, the work management system S visualizes the changes in task which occurs as a result of improvement in the efficiency of the identified task. In this manner, the work management system S can help users to improve the efficiency of the task performed in the workplace.

### [Structure of the Work Management System S]

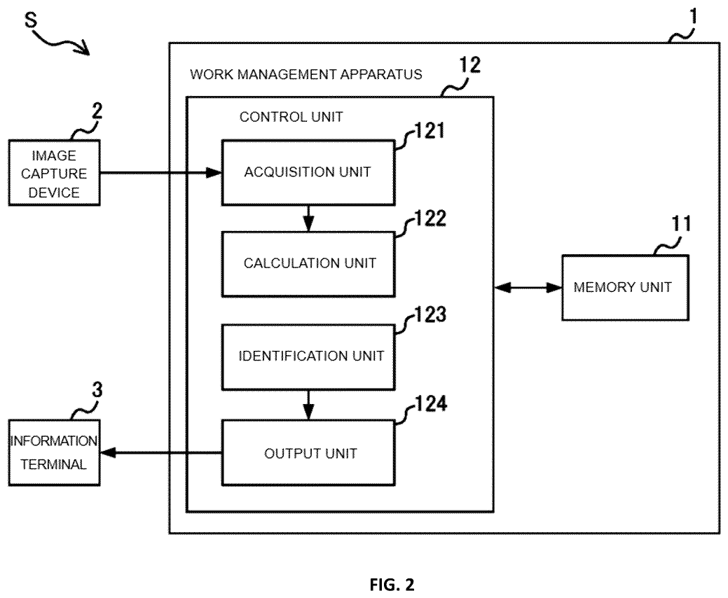

FIG. 2 is a block diagram of the work management system S according to the present embodiment. In FIG. 2, arrows indicate main data flows, and there may be data flows other than those shown in FIG. 2. In FIG. 2, each block shows configuration in functional units, rather than in hardware (device) units. Therefore, the blocks shown in FIG. 2 may be implemented within a single device, or may be implemented separately within a plurality of devices. Data may be exchanged between blocks via any means, including a data bus, a network, or a portable storage medium.

The work management apparatus 1 includes a memory unit 11 and a control unit 12. The memory unit 11 is a storage medium including a ROM (Read Only Memory), a RAM (Random Access Memory), a hard disk drive, etc. The memory unit 11 stores programs to be executed by the control unit 12 beforehand. The memory unit 11 may be provided outside the work management apparatus 1, and in this case, data may be transferred to and from the control unit 12 via a network.

The control unit 12 includes an acquisition unit 121, a calculation unit 122, an identification unit 123, and an output unit 124. The control unit 12 is a processor such as a CPU (Central Processing Unit). The control unit 12 executes programs stored in the memory unit 11 to function as the acquisition unit 121, the calculation unit 122, the identification unit 123, and the output unit 124.

The structure of executing the processes according to the present embodiment by the work management apparatus 1 will be described below. The acquisition unit 121 obtains stay information indicating the stay time of the worker in each of the plurality of areas. The worker performs the work in a workplace including the plurality of areas.

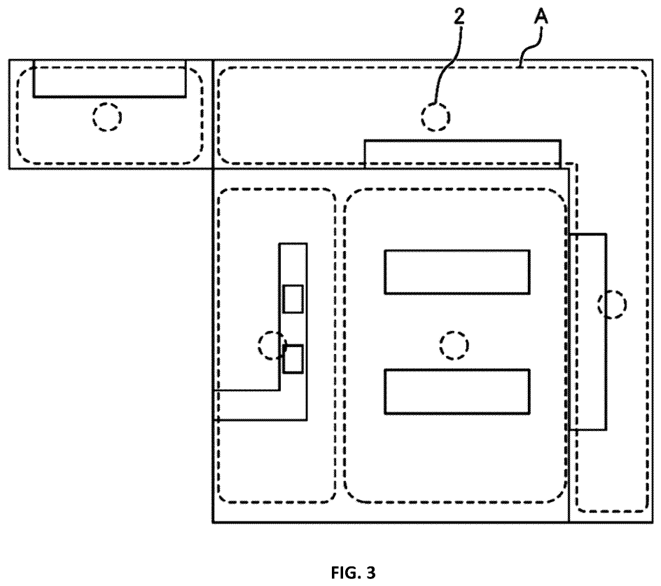

FIG. 3 is a schematic view illustrating a method of obtaining stay information by the acquisition unit 121. FIG. 3 shows a store, as the workplace, where products to be purchased by customers are displayed. The workplace includes a plurality of areas A. One area A corresponds to one task performed in this area A. Further, one area A may correspond to a plurality of tasks performed in this area A. For example, the plurality of areas A includes a cash register area for performing a settlement task, a confectionery area for displaying confectionery products, a walk-in area for replenishing products on the back side of the product display shelf, and a backroom area for performing a clerical task. The plurality of areas A is not limited to the specific areas shown herein, but may include other areas depending on the structure of the workplace.

A plurality of image capture devices 2 capable of capturing images of the plurality of areas A are provided in the workplace. For example, the image capture device 2 transmits a capture image generated by capturing an image of the area A at predetermined time intervals associated with the capture time at which the capture image was captured, to the work management apparatus 1.

In the work management apparatus 1, the acquisition unit 121 obtains the capture image transmitted from the image capture device 2. For example, the acquisition unit 121 identifies the area A where the worker was staying when the capture image was captured by the image capture device 2 by performing a process of detecting the shape and movement of a human body on the capture image transmitted by the image capture device 2. For example, in the case where the coordinates of a detected person in the capture image are within the coordinate range of a predefined area A, the acquisition unit 121 identifies the person as staying in the area A.

The acquisition unit 121 may obtain, instead of or in addition to the capture image transmitted by the image capture device 2, information indicating the status of wireless communication by a communication device (e.g., radio frequency identifier (RFID) tag) owned by the worker. In this case, a plurality of wireless communication antennas are provided in a plurality of areas A of the workplace for wireless communication. For example, the wireless communication antenna measures the status (e.g., communication strength) of wireless communication with the communication device owned by each of one or more workers at predetermined time intervals, and transmits information indicating such status associated with the communication time at which the communication occurred, to the work management apparatus 1.

In the work management apparatus 1, the acquisition unit 121 obtains information indicating the status of wireless communication transmitted by the wireless communication antenna. For example, the acquisition unit 121 identifies the area A where the worker was staying at the time of communication based on the communication strength between the communication device owned by the worker and each of a plurality of wireless communication antennas, shown by information about the status of wireless communication.

The acquisition unit 121 identifies the time period from the time when the worker started staying in the area A to the time when the worker finished staying in the area A as the stay time of the worker in the area A, and obtains the identified result as stay information. The acquisition unit 121 obtains the stay information indicating the stay time in each of the plurality of areas A for each of one or more workers.

Further, the acquisition unit 121 obtains a work schedule of the workers at the workplace. The work schedule is information indicating the period of time during which each of one or more workers is present at the workplace to perform work. For example, the acquisition unit 121 obtains a work schedule from an attendance management system in the workplace.

Further, the acquisition unit 121 obtains a delivery schedule for delivery of a target object of the work to the workplace. The delivery schedule is information indicating the time at which each of one or more target objects is scheduled to be delivered to the workplace. Delivery into the workplace includes, for example, delivery of products to a store or movement of products to a warehouse. The acquisition unit 121 obtains the delivery schedule, for example, from a schedule management system of the workplace.

Further, the acquisition unit 121 obtains information indicating the number of customers in the store as the workplace. For example, the acquisition unit 121 obtains settlement data which enables identification of the number of customers from a point-of-sale (POS) system of the store. The acquisition unit 121 may obtain information indicating the number of customers by other methods.

The calculation unit 122 calculates work actual condition data indicating the work time of the task performed in each of the plurality of areas A based on the stay time of the worker in each of the plurality of areas A identified by the acquisition unit 121.

For example, the calculation unit 122 calculates the total stay time of one or more workers in each of a plurality of areas A at intervals of a predetermined period of time (e.g., one hour) as the work time of the task performed in the area A. Further, at interval of a predetermined period, the calculation unit 122 may calculate the stay time of the worker in a certain area A (e.g., rest area) as non-work time during which the worker does not work.

Further, the calculation unit 122 may calculate the work time in the area A using the time period during which the worker actually performed the task corresponding to the area A in the stay time of the worker in the area A. In this case, for example, the calculation unit 122 performs a known image recognition process on the capture image transmitted by the image capture device 2, using an image representing the movement in the task registered in advance. In this manner, the calculation unit 122 identifies the time period during which the worker in area A actually performed the task. For example, for each of the plurality of areas A, the calculation unit 122 calculates the total time of the tasks actually performed by one or more workers for each predetermined time period as the work time of the task performed in the area A.

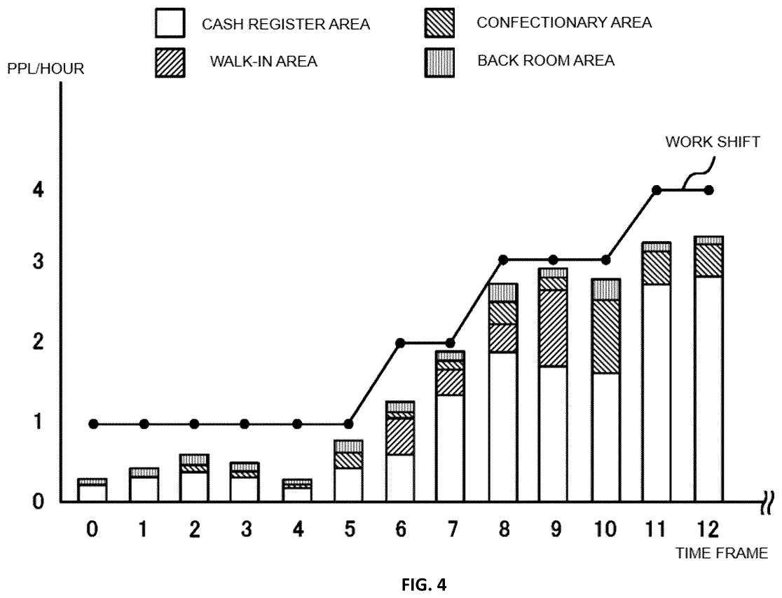

FIG. 4 is a schematic view showing exemplary work actual condition data calculated by the calculation unit 122. In FIG. 4, the horizontal axis represents the period and the vertical axis represents the work time. The period on the horizontal axis in FIG. 4 is represented by an hourly time frame. The work time on the vertical axis in FIG. 4 is represented by people/hour, which corresponds to one hour of work performed by one worker. In the example of FIG. 4, the name of the area A is represented as a label for each of the plurality of tasks, but the name of the task corresponding to the area A may also be represented. Further, FIG. 4 shows the number of workers for each time frame as indicated by the work schedule obtained by the acquisition unit 121, which is represented as a worker shift.

It should be note that there are timings at which the area where the worker is staying cannot be identified due to blind spots of the image capture device 2, errors in the process of detecting humans, and other factors. For this reason, in the example of FIG. 4, there is a difference between the work time and the worker shift. In an ideal situation where the worker can always identify the area where the worker is staying, the work time matches the worker shift.

In the example of FIG. 4, for example, tasks in the cash register area, the confectionery area, the walk-in area, and the backroom area are performed during the time frame of 6 o'clock. Further, for example, tasks in the cash register area, the confectionery area, and the backroom area are performed during the time frame of 12 o'clock. As described above, the calculation unit 122 can calculate the work time of the task performed in each of the plurality of areas A based on the stay time of the worker in each of the plurality of areas A.

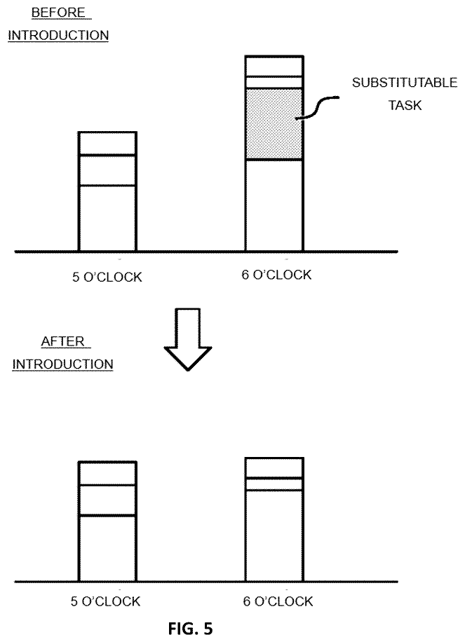

The identification unit 123 identifies a plurality of tasks of the work performed in the workplace which can be made more efficient by the method described using FIGS. 5, 6, and 7, respectively. FIG. 5 is a schematic view illustrating a method of identifying a substitutable task by the identification unit 123.

Based on the work actual condition data, the identification unit 123 identifies, in each of the plurality of time periods, a substitutable task which can be substituted or assisted by the introduction of the predetermined device among the plurality of tasks indicated by the work actual condition data. The introduced device includes at least one of a robot which performs work and a device or system used by the worker or a visitor to the workplace. The introduced device substitutes the task by performing the entire task or assists the task by performing the task in cooperation with the worker. Further, introduction of the device includes installation of application software which substitutes or assists the task on a terminal, a server, etc. already provided in the workplace.

Examples of robots include a product replenishment robot, a cooking robot, a cleaning robot, and a transportation robot. Examples of the devices or systems used by workers include a stock measuring instrument, an automatic ordering system, an automatic inspection device, a transportation device, etc. Examples of devices or systems used by the visitor include an unmanned settlement device, an electronic settlement system, etc.

For example, the memory unit 11 stores in advance information associated with the substitutable task and the device which substitutes or assists the substitutable task. The information terminal 3 may receive the work actual condition data shown in FIG. 4 from the work management apparatus 1 and display the work actual condition data on a display unit, and in response to operation by the user, may accept designation of the substitutable task among the plurality of tasks indicated by the work actual condition data, and may accept designation of a device which substitutes or assists the substitutable task. In this case, in the work management apparatus 1, the acquisition unit 121 obtains the information associated with the substitutable task and a device designated at the information terminal 3 and stores the information in the memory unit 11.

The identification unit 123 identifies the substitutable task by determining whether or not each of the plurality of tasks indicated by the work actual condition data corresponds to the substitutable task stored in the memory unit 11 in each of the plurality of time periods. Then, the identification unit 123 identifies the work time of the substitutable task as the amount which can be reduced in the work actual condition data.

In the example of FIG. 5, the identification unit 123 identifies one task: time frame of 6 o'clock as a substitutable task, and identifies that the work time for the task can be reduced. In this manner, the identification unit 123 can identify the task which can be reduced by introduction of the device, based on the work actual condition data.

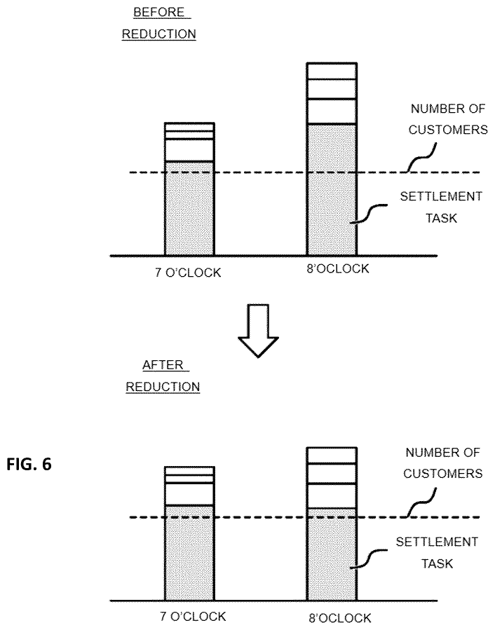

FIG. 6 is a schematic view illustrating a method of identifying a settlement task which can be reduced by the identification unit 123. For example, the settlement task is a task at a settlement device which accepts settlement by a customer in a cash register area of a store.

The identification unit 123 identifies the settlement task which can be reduced based on the work time of the settlement task indicated by the work actual condition data and the number of customers obtained by the acquisition unit 121 in each of the plurality of time periods. For example, the identification unit 123 obtains the relationship between the number of customers and the ideal work time of the settlement task stored in the memory unit 11 in advance, and obtains the ideal work time associated with the number of customers obtained by the acquisition unit 121 in the relationship. The identification unit 123 identifies a settlement task for which the work time indicated by the work actual condition data is longer than the ideal work time by a predetermined value or more, as the settlement task which can be reduced. Further, for the settlement task which can be reduced, the identification unit 123 identifies a value obtained by subtracting the ideal work time from the work time indicated by the work actual condition data as the amount of reduction which can be achieved.

In the example of FIG. 6, the identification unit 123 identifies that the settlement task can be reduced during the time frame of 8 o'clock. In this manner, the identification unit 123 can identify the settlement task in correspondence with the number of customers based on the work actual condition data.

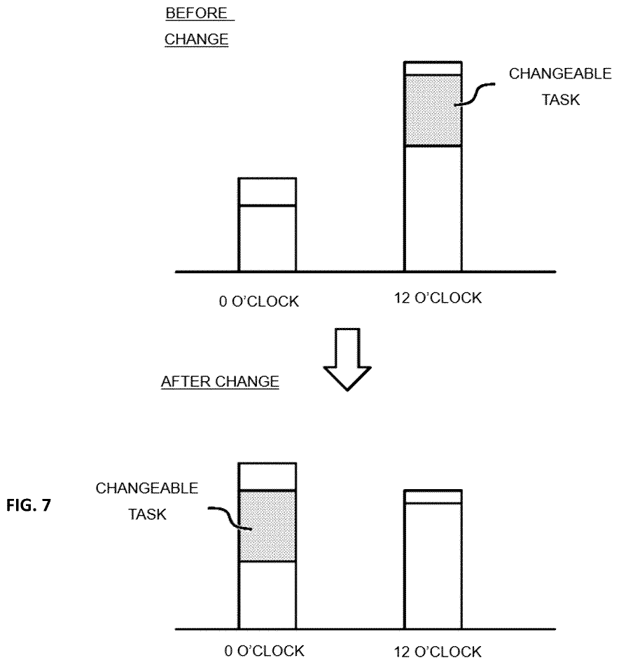

FIG. 7 is a schematic diagram illustrating a method of identifying the changeable task by the identification unit 123. Based on the work actual condition data, the identification unit 123 identifies, among the plurality of tasks indicated by the work actual condition data, a changeable task which can be changed from the time period in which the changeable task is performed to another time frame, and identifies the other time frame in which the changeable task is performed. The memory unit 11 stores in advance a work schedule indicating the time frame (period of time) during which each of the plurality of tasks is performed. In the work schedule, for example, it is determined that tasks such as displaying lunch boxes or delivering products into the workplace and from the workplace are performed in a certain time frame. In contrast, for example, tasks which are not determined to be performed at certain time frames in the work schedule, such as cleaning or organizing can be presumed as tasks which can be changed to other time frames. So, for example, the identification unit 123 identifies a plurality of tasks which are not determined to be performed at certain time frames in the task schedule stored in the memory unit 11 as changeable tasks.

For example, the identification unit 123 identifies a time frame in which the work actual condition data indicates that the worker is not performing any task as the other time frame. For example, the identification unit 123 may identify a time frame in which the work actual condition data indicates that the worker is present in a certain area (e.g. a rest area) as the other time frame. Then, the identification unit 123 associates the identified changeable task and the other time frame to identify that the identified changeable task can be changed to the other time frame.

Further, the identification unit 123 may identify the changeable task based on the delivery schedule obtained by the acquisition unit 121. For example, the identification unit 123 identifies, in each of the plurality of periods, a task relating to the products or goods to be delivered into the workplace in the period as not identifiable as the changeable task for the period, and identifies the other tasks as the changeable tasks for the period. In this manner, the identification unit 123 can prevent tasks such as the display of products or goods delivered into the workplace from being changed to other time frames.

Further, for example, the identification unit 123 may identify other time frame not to include the time of delivery of the products or goods into the workplace. In this manner, the identification unit 123 can suppress interruption of the delivery operation by adding changeable tasks to the time frame when the products or goods are delivered into the workplace.

In the example of FIG. 7, the identification unit 123 identifies that the changeable task in the time frame of 12 o'clock can be changed to the time frame of 0 o'clock. In this manner, the identification unit 123 can identify the task which can be changed to another time frame based on the work actual condition data.

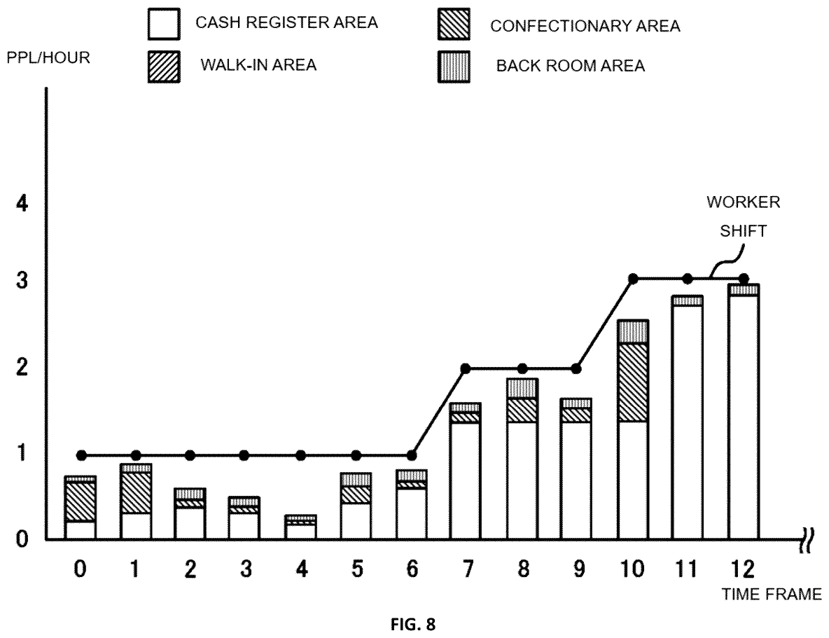

FIG. 8 is a schematic diagram showing exemplary work actual condition data when the efficiency of the task identified by the identification unit 123 is improved. The vertical axis and horizontal axis of the graph in FIG. 8 are the same as those in FIG. 4. In the example of FIG. 8, the name of the area A is shown as a label for each of a plurality of tasks. Alternatively, the name of the task corresponding to the area A may be shown.

The work actual condition data in FIG. 8 represents the simulation results of the case where, in the work actual condition data in FIG. 4, the work time for the substitutable task is reduced by introducing a predetermined device, the work time for the settlement task is reduced according to the number of customers, and the changeable task is changed to another time frame. That is, the work actual condition data in FIG. 8 shows a work schedule indicating the task to be performed in each of a plurality of periods when the efficiency of the task identified by the identification unit 123 is improved.

Further, FIG. 8 shows the worker shift generated based on the work actual condition data in the case where the efficiency of the task identified by the identification unit 123 is improved. For example, the identification unit 123 calculates the number of workers required for the total work time of one or more tasks in each of the plurality of periods, and generates the calculated number of workers as a worker shift.

The output unit 124 generates, based on the work actual condition data, change information corresponding to the change in the task performed by the worker in the case where the efficiency of the task identified by the identification unit 123 is improved. The change information includes information corresponding to at least one of (1) reducing the work time of the changeable task by introduction of a predetermined device, (2) reducing the work time of the settlement task according to the number of customers, and (3) changing the changeable task to another time frame. For example, the change information is information indicating a change in at least one of the task, the work time, the number of workers, and the labor cost of the workers.

Firstly, change information regarding reduction of the work time for a substitutable task by introduction of a predetermined device will be described. The output unit 124 generates change information corresponding to changes in the task performed by the worker caused by the introduction of the device, based on the relationship between the work time indicated by the work actual condition data and the substitutable task which can be substituted or assisted by introduction of the predetermined device identified by the identification unit 123.

For example, the output unit 124 calculates, possible reduction in at least one of the number of workers or the labor cost of the workers, corresponding to the possible reduction in work time of the substitutable task identified by the identification unit 123. Then, the output unit 124 generates change information including information indicating at least one of the substitutable task (i.e. the name of the task), the work time, the number of workers, and the labor cost of the workers, which are reduced by introduction of the device. In this manner, the output unit 124 can visualize the changes in the task performed by the worker caused by introduction of the predetermined device, based on the stay time of the worker in each of the plurality of areas of the workplace.

For example, the output unit 124 may generate change information including information comparing the work time before introduction of the device with the work time after introduction of the device. In this case, for example, the change information includes, the difference between the work time before introduction of the device and the work time after introduction of the device. Further, for example, the change information may include both of the work time before introduction of the device and the work time after introduction of the device.

Further, the output unit 124 may generate change information, including the number of introduced devices, based on the relationship between the work time of each of the plurality of tasks indicated by the work actual condition data, and the substitutable task. For example, the memory unit 11 stores in advance information obtained by associating the work time with the number of devices required to substitute or assist the task for the work time. The output unit 124 obtains the number of devices associated with the work time of the substitutable task in the memory unit 11. In this manner, the output unit 124 can suggest an appropriate number of devices according to the work time of the substitutable task.

Further, the output unit 124 may generate change information including a work schedule indicating the plurality of tasks indicated by the work actual condition data and the auxiliary tasks which need to be performed by the worker as a result of introduction of the device. For example, in the case where a robot is introduced into the workplace, a new auxiliary task to maintain the robot becomes necessary. For example, the memory unit 11 stores in advance information obtained by associating the introduced device with the auxiliary task which is required to be performed by the worker as a result of introduction of the device. The output unit 124 generates a work schedule by adding the auxiliary task associated with the introduced device in the memory unit 11 to the plurality of tasks indicated by the work actual condition data. In this manner, the output unit 124 can suppress omission of consideration of the auxiliary task which becomes necessary as a result of introduction of the predetermined device.

Secondly, change information about reducing the work time of the settlement task according to the number of customers will be explained. The output unit 124 calculates, for example, the amount of possible reduction in at least one of the number of workers or the labor cost of the workers, corresponding to the amount of possible reduction in the work time of the settlement task identified by the identification unit 123. Then, the output unit 124 generates change information which includes information indicating the amount of reduction which can be made in at least one of the work time, the number of workers, and the labor cost of the workers in the settlement task. In this manner, the output unit 124 can visualize the settlement task which can be reduced, based on the stay time of the worker in each of the plurality of areas of the workplace.

Third, change information relating to changing the changeable task to another time frame will be described. For example, the output unit 124 generates change information including information obtained by associating the changeable task with the other time frame identified by the identification unit 123. Further, for example, the output unit 124 calculates the amount of possible reduction in at least one of the number of workers or the labor cost of the workers by changing the changeable task identified by the identification unit 123 to the other time frame. Further, the output unit 124 generates change information which includes at least one of the number of workers and the labor cost of the workers, which are reduced by changing the changeable task to the other time frame. In this manner, the output unit 124 can visualize the change in the task performed by workers caused by changing the task to the other time frame, based on the stay time of the worker in each of the plurality of areas in the workplace.

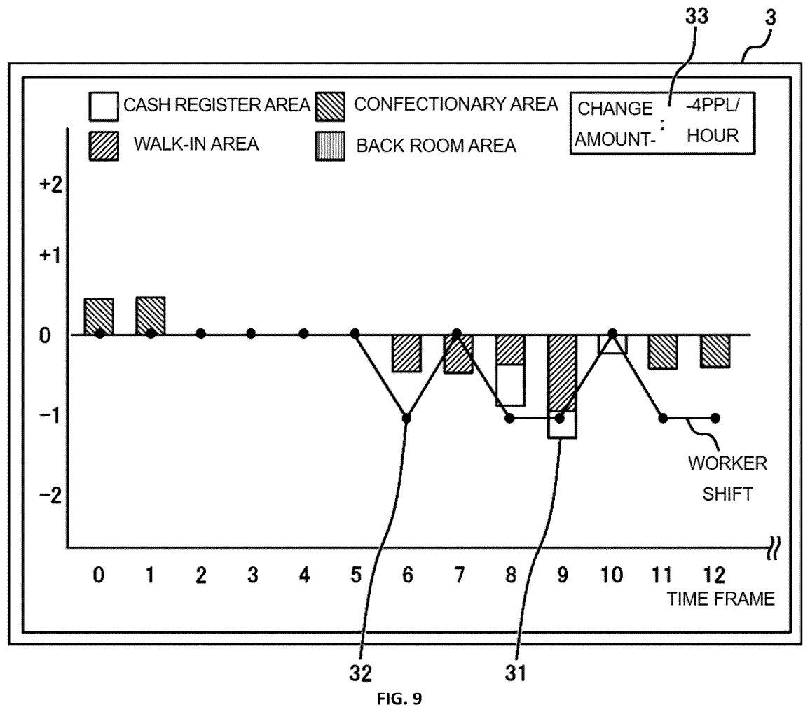

The output unit 124 transmits the generated change information to the information terminal 3. The information terminal 3 displays the change information transmitted from the work management apparatus 1 on the display unit. FIG. 9 is a schematic diagram of information terminal 3 displaying exemplary change information.

FIG. 9 shows a graph 31 illustrating the difference between the work actual condition data calculated by the calculation unit 122 and the work actual condition data in the case where the efficiency of the task identified by the identification unit 123 is improved, as change information. The vertical axis and the horizontal axis of the graph in FIG. 8 are the same as those in FIG. 4. The graph 31 shows the decreased work time as a negative value and the increased work time as a positive value in each of a plurality of time periods.

Further, FIG. 9 shows the worker shift change amount 32, indicating the difference between the worker shift (i.e. the number of workers) indicated by the work schedule obtained by the acquisition unit 121 and the worker shift generated by the identification unit 123, as the change information. The worker shift change amount 32 represents the decreased worker shift with a negative value and represents the increased worker shift with a positive value in each of the plurality of time periods. Further, FIG. 9 shows a work time change amount 33 representing the total amount of work time which can be reduced in one day, as the change information. In this manner, the user can easily recognize the change in the task in the case where the efficiency of the task identified by the identification unit 123 is improved at the information terminal 3.

The output unit 124 is not limited to the specific information illustrated herein, and may output other information corresponding to changes in the task performed by the worker as the change information. For example, the output unit 124 may output both the work actual condition data calculated by the calculation unit 122 illustrated in FIG. 4 and the work actual condition data in the case where efficiency of the task is identified by the identification unit 123 illustrated in FIG. 8 is improved. Further, the output unit 124 may superimpose, and display the worker shift on the work actual condition data to enable the work actual condition data and the worker shift (work schedule) to be displayed in contrast to each other.

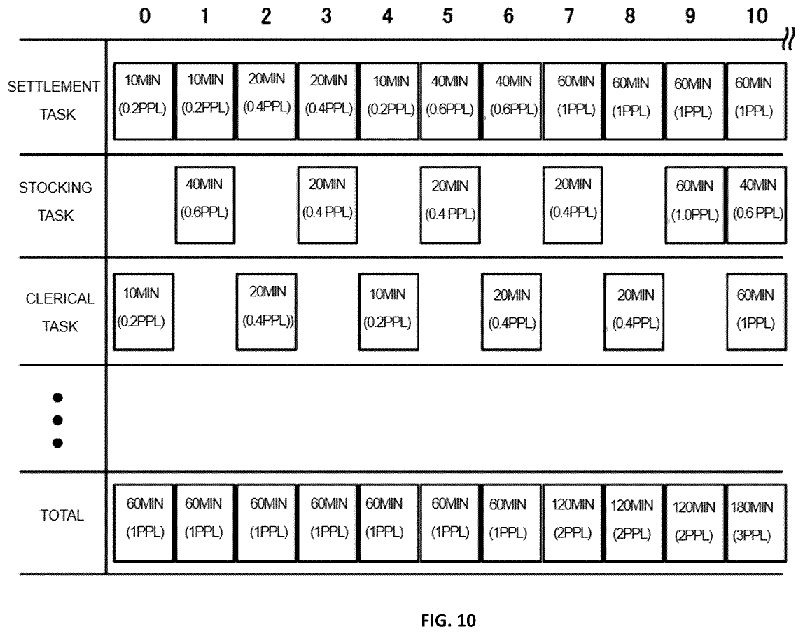

Further, the output unit 124 may output a table showing the content of the task which needs to be assigned to each time frame, the work time and the number of workers, based on the work actual condition data in the case where the efficiency of the task identified by the identification unit 123 is improved. FIG. 10 is a schematic diagram of a table showing data in the case where the efficiency of the task identified by the identification unit 123 is improved.

FIG. 10 shows a table consisting of rows indicating tasks (vertical axis) and columns indicating time frames (horizontal axis). One task may be divided into a plurality of lines. For example, the settlement task can be divided into a line of a customer service task and a line of a cash register closing task. Each cell in the table of FIG. 10 represents the work time (people/hour) and the number of workers in the case where efficiency of task is improved. That is, FIG. 10 shows the content of the task which needs to be assigned to each time frame, the duration of the task and the number of workers in the case where the efficiency of the task is improved. Further, the bottom line of the table in FIG. 10 shows the total work time and number of workers for all of tasks in each time frame.

In this manner, the user can easily recognize the content of the task, the work time and the number of workers required in the case where the efficiency of the task identified by the identification unit 123 is improved, at the information terminal 3 for each time frame. Thus, it becomes easier to assign a worker to each time frame.

The table in FIG. 10 is an example, and other display modes may be used to show the content of the task which needs to be assigned, the work time and the number of workers for each time frame. For example, the output unit 124 may output a table in which the content of the task, the work time, and the number of workers are arranged in the horizontal axis direction for each time frame.

### [Flow of the Information Processing Method]

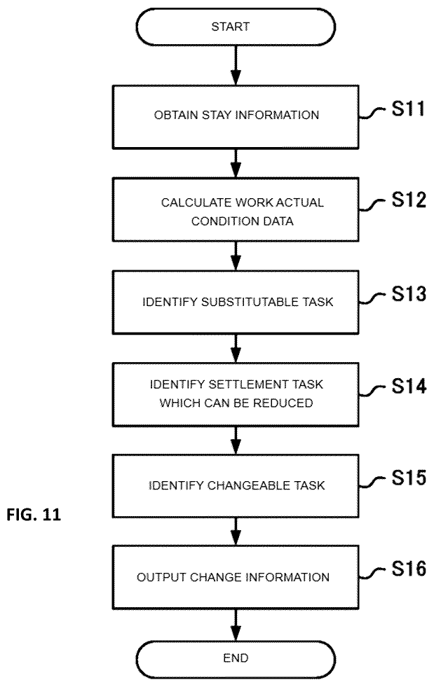

FIG. 11 shows a flowchart of the information processing method performed by the work management apparatus 1 according to the present embodiment. The acquisition unit 121 obtains stay information indicating the stay time in each of the plurality of areas of a worker working in the workplace including the plurality of areas (S11). For example, the acquisition unit 121 obtains the image captured by the image capture device 2 or information indicating the status of wireless communication by a communication device owned by the worker. For example, the acquisition unit 121 identifies the stay time of the worker in each of the plurality of areas based on the capture image or the status of wireless communication, and obtains the identified results as stay information.

The calculation unit 122 calculates work actual condition data indicating the work time of the task performed in each of the plurality of areas based on the stay time of the workers in each of the plurality of areas identified by the acquisition unit 121 (S12). For example, the calculation unit 122 calculates, for each of the plurality of areas, the total stay time of the worker for each of the predetermined periods, or the total time of the tasks actually performed by the worker for each of the predetermined periods, as the work time of the task performed in the area.

Based on the work actual condition data, the identification unit 123 identifies, in each of the plurality of periods, a substitutable task which can be substituted or assisted by introduction of the predetermined device (S13), among the plurality of tasks indicated by the work actual condition data. The identification unit 123 identifies the settlement task which can be reduced based on the work time of the settlement task indicated by the work actual condition data and the number of customers obtained by the acquisition unit 121 in each of the plurality of periods (S14). Based on the work actual condition data, the identification unit 123 identifies a changeable task which can be changed from the time period in which the plurality of tasks indicated by the work actual condition data are performed to another time period, and also identifies the other time period in which the changeable task is performed (S15). The identification unit 123 may perform only some of identifying the substitutable task in step S13, identifying the settlement task which can be reduced in step S14 and identifying the task which can be changed in step S15.

The output unit 124 generates change information corresponding to changes in the task performed by the worker in the case where the efficiency of the task identified by the identification unit 123 is improved, based on the work actual condition data, and outputs the generated change information (S16). The change information is the information corresponding to one of reducing the work time of the substitutable task by introduction of the predetermined device identified in step S13, reducing the work time of the settlement task identified in step S14, and changing the identified changeable task to the other time frame in step S15.

The output unit 124 transmits the generated change information to the information terminal 3. The information terminal 3 displays the change information transmitted from the work management apparatus 1 on the display unit.

### [Working Effect of the Embodiment]

The work management system S according to the present embodiment calculates work actual condition data indicating the work time of the task performed in each of the plurality of areas based on the stay time of the worker in each of a plurality of areas of the workplace, and identifies the task which can be made more efficient based on the work actual condition data. Further, the work management system S visualizes the changes in the task which occur as a result of improvement in the identified task. In this manner, the work management system S can make it easier for users to improve the efficiency of the task performed by the user in the workplace.

Although the present invention has been described using the embodiments, the technical scope of the present disclosure is not limited to the scope described in the above embodiments, and various modifications and changes can be made within the scope of the gist of the present disclosure. For example, all or part of the apparatus, in any unit, can be configured to be functionally or physically distributed or integrated. Further, any new form of embodiments derived from any combination of a plurality of embodiments are also encompassed within the embodiments of the present disclosure. The effects of the new form of embodiments derived from combination of embodiments have the effects of the original embodiments as well.

Each of the steps (processes) included in the information processing method shown in FIG. 11 is performed by the processor of the work management apparatus 1. That is, the processor of the work management apparatus 1 executes the program for performing the information processing method shown in FIG. 11 to control the various parts of the work management system S, to perform the information processing method shown in FIG. 11. Some of the steps included in the information processing method shown in FIG. 11 may be omitted, and the order of the steps may be changed. A plurality of steps may be performed in parallel.

1. An information processing apparatus comprising:
a control unit configured to perform:
obtaining information indicating stay time of a worker in each of a plurality of areas, the worker performing work in a workplace including the plurality of areas;
calculating work actual condition data indicating work time of the work performed in each of the plurality of areas based on the stay time;
identifying a substitutable task which is substituted or assisted by introduction of a predetermined device, among a plurality of tasks of the work performed in the workplace; and
outputting change information corresponding to a change in the task performed by the worker by introduction of the device, based on relationship between the work time of each of the plurality of tasks indicated by the work actual condition data and the substitutable task; and
a storage device configured to store the substitutable task and information associating the substitutable task with the device which substitutes or assists the substitutable task,
wherein the identifying includes identification of the substitutable task by determining whether or not the task indicated by the work actual condition data corresponds to the substitutable task stored in the storage device.

2. The information processing apparatus according to claim 1, wherein the control unit is further configured to perform:
calculating the work actual condition data indicating the work time of each of the plurality of tasks in each predetermined time period;
determining whether or not each of the plurality of tasks corresponds to the substitutable task, in each of a plurality of the time periods; and
outputting the change information corresponding to a result of the determining.

3. The information processing apparatus according to claim 1, wherein the device includes at least one of a robot configured to perform the work and a device or a system used by the worker or a visitor of the workplace.

4. The information processing apparatus according to claim 1, wherein the change information includes information for contrasting work time before introduction of the device with work time after introduction of the device.

5. The information processing apparatus according to claim 1, wherein the change information includes information indicating at least one of the task, the work time, the number of the workers, and the labor cost of the workers, which are reduced by introduction of the device.

6. The information processing apparatus according to claim 1, wherein the change information includes a work schedule indicating the task and auxiliary task which needs to be performed by introduction of the device.

7. The information processing apparatus according to claim 1, wherein the control unit is further configured to perform:
outputting information indicating the number of the introduced devices, based on relationship between the work time of each of the plurality of tasks indicated by the work actual condition data and the substitutable task.

8. The information processing apparatus according to claim 1, wherein the workplace includes a store where products to be purchased by a customer are displayed,
the control unit is further configured to perform:
obtaining information indicating the number of customers in the store; and
based on the work time in a settlement device for accepting settlement by the customer, and the number of the customers, outputting information indicating an amount which can be reduced in at least one of the work time in the settlement device, the number of workers, and labor cost of the workers.

9. The information processing apparatus according to claim 1, wherein the control unit is further configured to perform:
identifying, among the plurality of tasks, a changeable task for which the time frame of performing the task can be changed to another time frame, and the other time frame, based on the work actual condition data; and
associating, and output the changeable task and the other time frame.

10. The information processing apparatus according to claim 9, wherein the other time frame is a time frame where the actual condition data indicates that the worker is not performing the task.

11. The information processing apparatus according to claim 9 wherein the control unit is further configured to perform:
among the plurality of tasks, identifying the task which is not determined to be performed in a certain time frame as the changeable task.

12. The information processing apparatus according to claim 1, wherein the control unit is further configured to perform:
obtaining information indicating a delivery schedule for delivering a target object of the task into the workplace; and
identifying the changeable task based on the delivery schedule.

13. The information processing apparatus according to claim 1, wherein the control unit is further configured to perform:
outputting information indicating at least one of the number of workers and the labor cost of the workers which can be reduced by changing the changeable task to the other time frame.

14. An information processing method performed by a processer of an information processing apparatus having a storage device, the method comprising:
obtaining information indicating stay time of a worker in each of a plurality of areas, the worker performing work in a workplace including the plurality of areas;
calculating work actual condition data indicating work time of the work performed in each of the plurality of areas based on the stay time;
identifying a substitutable task which is substituted or assisted by introduction of a predetermined device, among a plurality of tasks of the work performed in the workplace; and
outputting change information corresponding to a change in the task performed by the worker by introduction of the device, based on relationship between the work time of each of the plurality of tasks indicated by the work actual condition data and the substitutable task,
wherein the storage device is configured to store the substitutable task and information associating the substitutable task with the device which substitutes or assists the substitutable task, and
wherein the identifying includes identification of the substitutable task by determining whether or not the task indicated by the work actual condition data corresponds to the substitutable task stored in the storage device.

15. An information processing apparatus comprising:
a control unit configured to perform:
obtaining information indicating stay time of a worker in each of a plurality of areas, the worker performing work in a workplace including the plurality of areas;
calculating work actual condition data indicating work time of the work performed in each of the plurality of areas based on the stay time;
identifying, among a plurality of tasks of the work, a changeable task for which the time frame of performing the task can be changed to another time frame, and the other time frame, based on the work actual condition data; and
associating and outputting the changeable task and the other time frame; and
a storage device configured to store a work schedule indicating a time frame during which each of the plurality of tasks is performed,
wherein the identifying includes, among the plurality of tasks, identification of the task which is not determined to be performed in a certain time frame as the changeable task.

16. An information processing method performed by a processor of an information processing apparatus having a storage device and the processor, the method including:
obtaining information indicating stay time of a worker in each of a plurality of areas, the worker performing work in a workplace including the plurality of areas;
calculating work actual condition data indicating work time of the work performed in each of the plurality of areas based on the stay time;
identifying, among a plurality of tasks of the work, a changeable task for which the time frame of performing the task can be changed to another time frame, and the other time frame, based on the work actual condition data; and
associating and outputting the changeable task and the other time frame,
wherein the storage device is configured to store a work schedule indicating a time frame during which each of the plurality of tasks is performed; and
wherein the identifying includes, among the plurality of tasks, identification of the task which is not determined to be performed in a certain time frame as the changeable task.
